(19) United States
(12) Patent Application Publication
(10) Pub. No.: US 2018/0095473 A1
(43) Pub. Date: Apr. 5, 2018

(54) AUTONOMOUS ELECTRIC VEHICLE FOR TRANSPORTATION OF GOODS AND/OR PEOPLE

(71) Applicant: NAVYA, Villeurbanne (FR)

(72) Inventors: Nizar FAKHFAKH, Poissy (FR); Pascal LECUYOT, Paris (FR); Hassane OUCHOUID, Asnieres-Sur-Seine (FR)

(21) Appl. No.: 15/284,206

(22) Filed: Oct. 3, 2016

(51) Int. Cl. G05D 1/02; B60W 50/08; B60W 30/095; G05D 1/00

(52) U.S. Cl. CPC G05D 1/0246; B60W 50/082; B60W 30/0956; G05D 2201/0213; G05D 1/0278; B60W 2420/42; B60W 2420/52; G05D 1/0088

(57) ABSTRACT

The autonomous electric vehicle includes an exteroceptive sensor set configured to obtain information about an environment in which the autonomous electric vehicle is located, the exteroceptive sensor set including a lower active exteroceptive sensor arranged at a lower front part of the autonomous electric vehicle, an intermediary active exteroceptive sensor arranged at an intermediary front part of the autonomous electric vehicle, an intermediary passive exteroceptive sensor arranged at the intermediary front part of the autonomous electric vehicle, an upper active exteroceptive sensor arranged at an upper front part of the autonomous electric vehicle, and an upper passive exteroceptive sensor arranged at the upper front part of the autonomous electric vehicle.

### FIELD OF THE INVENTION

The present invention relates to an autonomous electric vehicle, and particularly a fully autonomous electric vehicle, for transportation of goods and/or people.

### BACKGROUND OF THE INVENTION

As known, a fully autonomous electric vehicle includes:

an exteroceptive sensor set configured to obtain information about an environment in which the autonomous electric vehicle is located,

a proprioceptive sensor set configured to obtain information about a displacement of the autonomous electric vehicle,

control unit configured to process and analyze the information obtained by the exteroceptive sensor set and the proprioceptive sensor set, in order to identify objects and/or features in the environment in which the autonomous electric vehicle is located, including for example lane information, traffic signals and obstacles, and configured to control, in an autonomous control mode, the autonomous electric vehicle based on the information obtained by the exteroceptive sensor set and the proprioceptive sensor set.

In order to ensure a reliable and safe control of such an autonomous electric vehicle, the exteroceptive sensor set of the latter requires a very large number of exteroceptive sensors located at various locations on the autonomous electric vehicle, which significantly increases the cost of the autonomous electric vehicle and significantly increases the complexity of the control unit, and more particularly of the processing and analyzing algorithms for processing and analyzing the information obtained by the exteroceptive sensor set. Further such a complexity of the control unit may, in some events, induce an inappropriate control of the autonomous electric vehicle which could be harmful for the passengers of the autonomous electric vehicle.

### SUMMARY OF THE INVENTION

It is an object of the present invention to provide an improved autonomous electric vehicle which can overcome the drawbacks encountered in conventional autonomous electric vehicles.

Another object of the present invention is to provide an autonomous electric vehicle which is reliable and safe, and particularly which can detect reliably any obstacles in vicinity of the autonomous electric vehicle.

According to the invention such an autonomous electric vehicle includes an exteroceptive sensor set configured to obtain information about an environment in which the autonomous electric vehicle is located, the exteroceptive sensor set including:

a lower active exteroceptive sensor arranged at a lower front part, for example at a lower front part of the front face, of the autonomous electric vehicle and configured to sense or detect objects and/or features in the environment in which the autonomous electric vehicle is located, the lower active exteroceptive sensor providing a lower scanning plane substantially horizontal,

an intermediary active exteroceptive sensor arranged at an intermediary front part, for example at an intermediary front part of the front face, of the autonomous electric vehicle and configured to sense or detect objects and/or features in the environment in which the autonomous electric vehicle is located, the intermediary active exteroceptive sensor providing an intermediary scanning plane substantially horizontal,

an intermediary passive exteroceptive sensor arranged at the intermediary front part, for example at the intermediary front part of the front face, of the autonomous electric vehicle and configured to capture images or a video of the environment in which the autonomous electric vehicle is located, for example the road on which the autonomous electric vehicle is located and vicinity of the road,

an upper active exteroceptive sensor arranged at an upper front part, for example at an upper front part of the front face, of the autonomous electric vehicle and configured to sense or detect objects and/or features in the environment in which the autonomous electric vehicle is located, the upper active exteroceptive sensor providing a plurality of scanning planes, and

an upper passive exteroceptive sensor arranged at the upper front part, for example at the upper front part of the front face, of the autonomous electric vehicle and configured to capture images or a video of the environment in which the autonomous electric vehicle is located.

By providing the exteroceptive sensor set with heterogeneous exteroceptive sensors located at various heights on the autonomous electric vehicle and having various scanning planes, the exteroceptive sensor set can reliably and redundantly detect objects and/or features (for example pedestrians, cars, bicycles, pets, small objects located on the floor and having a 20 cm height, large size vehicles) in the environment in which the autonomous electric vehicle is located, which ensures a reliable and safe control of the autonomous electric vehicle while limiting the cost of the latter.

Further such a particular architecture of the exteroceptive sensor set allows taking advantage of some types of exteroceptive sensors and circumventing the limitations of some others types of exteroceptive sensors.

The autonomous electric vehicle may also include one or more of the following features, taken alone or in combination.

According to an embodiment of the invention, the autonomous electric vehicle is a fully autonomous electric vehicle.

According to an embodiment of the invention, the lower active exteroceptive sensor and the intermediary active exteroceptive sensor are arranged respectively at a central portion of the lower front part of the front face and a central portion of the intermediary front part of the front face.

According to an embodiment of the invention, the autonomous electric vehicle has a longitudinal axis.

According to an embodiment of the invention, the lower active exteroceptive sensor has a field of view centered on a first optical axis that is substantially parallel or coincident with a longitudinal axis of the autonomous electric vehicle.

According to an embodiment of the invention, the intermediary active exteroceptive sensor has a field of view centered on a second optical axis that is substantially parallel or coincident with a longitudinal axis of the autonomous electric vehicle.

According to an embodiment of the invention, the lower active exteroceptive sensor, the intermediary active exteroceptive sensor and the upper active exteroceptive sensor are arranged at different heights.

According to an embodiment of the invention, at least one of the lower active exteroceptive sensor, the intermediary active exteroceptive sensor and the upper active exteroceptive sensor is a Lidar sensor, i.e. a light detection and ranging sensor.

According to an embodiment of the invention, each of the lower active exteroceptive sensor, the intermediary active exteroceptive sensor and the upper active exteroceptive sensor is a Lidar sensor.

According to an embodiment of the invention, the upper active exteroceptive sensor is a real-time Lidar sensor.

According to an embodiment of the invention, the upper active exteroceptive sensor is a multi-layer Lidar sensor, also named multi-channel Lidar sensor.

According to an embodiment of the invention, the upper active exteroceptive sensor is a 16-layer Lidar sensor, also named 16-channel Lidar sensor, such as a VLP-16.

According to an embodiment of the invention, the upper active exteroceptive sensor is configured to provide an upper scanning plane substantially horizontal and a plurality of inclined scanning planes which are vertically inclined with respect to a horizontal plane. These provisions allow maximizing the overlap zones of the exteroceptive sensors, and thus improving the reliability of the information detected by the exteroceptive sensor set.

According to an embodiment of the invention, the upper active exteroceptive sensor is configured to generate, for example simultaneously, a plurality of scanning beams, for example infrared scanning beams, in different directions, each of the upper scanning plane and of the inclined scanning planes being defined by the scanning displacement of a respective one of the scanning beams.

According to an embodiment of the invention, the upper active exteroceptive sensor is configured to provide a plurality of successive inclined scanning planes having increasing angular orientations, measured along a common axis, with respect to the upper scanning plane. In others words, each successive inclined scanning plane has an angular orientation, measured along the common axis and with respect to the upper scanning plane, which is greater than the angular orientation of any preceding inclined scanning plane as measured along the common axis and with respect to the upper scanning plane.

According to an embodiment of the invention, each of the upper scanning plane and of the inclined scanning planes has a vertical angular resolution of about 2°.

According to an embodiment of the invention, the upper active exteroceptive sensor is configured to provide a horizontal upper scanning plane and fifteen inclined scanning planes from about −2° with a horizontal plane to about −30° with the horizontal plane.

According to an embodiment of the invention, the upper active exteroceptive sensor is inclined with respect to a horizontal plane.

According to an embodiment of the invention, the upper active exteroceptive sensor is inclined downwardly at an inclination angle between 10 and 20 degrees.

According to an embodiment of the invention, the inclination angle of the upper active exteroceptive sensor is about 15 degrees.

According to an embodiment of the invention, the upper active exteroceptive sensor has a 30° vertical field of view.

According to an embodiment of the invention, the upper active exteroceptive sensor has a 30° vertical field of view with ±15° up and down.

According to an embodiment of the invention, the upper active exteroceptive sensor has a 360° horizontal field of view.

According to an embodiment of the invention, the upper active exteroceptive sensor includes a laser source configured to emit laser scanning beams and a detector configured to receive reflections of the laser scanning beams.

According to an embodiment of the invention, at least one of the lower active exteroceptive sensor and the intermediary active exteroceptive sensor is a single-layer Lidar sensor, also named single-channel Lidar sensor.

According to an embodiment of the invention, each of the lower active exteroceptive sensor and the intermediary active exteroceptive sensor is a single-layer Lidar sensor, for example a Sick Lidar sensor, such as a Sick LMS151.

According to an embodiment of the invention, at least one of the lower active exteroceptive sensor and the intermediary active exteroceptive sensor has a viewing angle of about 180°.

According to an embodiment of the invention, each of the lower active exteroceptive sensor and the intermediary active exteroceptive sensor has a viewing angle of about 180°.

According to an embodiment of the invention, each of the lower active exteroceptive sensor and the intermediary active exteroceptive sensor includes a laser source configured to emit a laser scanning beam and a detector configured to receive reflections of the laser scanning beam.

According to an embodiment of the invention, the lower active exteroceptive sensor is arranged at a first distance, from a support surface, particularly a horizontal support surface, on which the autonomous electric vehicle is located (in other words from a lower contact surface of the autonomous electric vehicle), between 0.20 and 0.40 meter.

According to an embodiment of the invention, the support surface is a road, a lane, a parking lot or the like.

According to an embodiment of the invention, the lower contact surface is the lower surface of the wheels of the autonomous electric vehicle.

According to an embodiment of the invention, the first distance is about 0.30 meter.

According to an embodiment of the invention, the intermediary active exteroceptive sensor is arranged at a second distance, from a support surface, particularly a horizontal support surface, on which the autonomous electric vehicle is located, between 0.50 and 1 meter.

According to an embodiment of the invention, the second distance is between 0.65 and 0.85 meter, and for example is about 0.74 meter.

According to an embodiment of the invention, the upper active exteroceptive sensor is arranged at a third distance, from a support surface, particularly a horizontal support surface, on which the autonomous electric vehicle is located, higher than 2.20 meters.

According to an embodiment of the invention, the third distance is between 2.20 and 2.50 meters, and for example is about 2.34 meters.

According to an embodiment of the invention, the intermediary passive exteroceptive sensor is arranged at a fourth distance, from a support surface, particularly a horizontal support surface, on which the autonomous electric vehicle is located, between 1 and 1.40 meter.

According to an embodiment of the invention, the fourth distance is between 1.10 and 1.40 meter, and for example about 1.38 meter.

According to an embodiment of the invention, the upper passive exteroceptive sensor is arranged at a fifth distance, from a support surface, particularly a horizontal support surface, on which the autonomous electric vehicle is located, higher than 2 meters.

According to an embodiment of the invention, the fifth distance is between 2 and 2.50 meters, and for example is about 2.34 meters.

According to an embodiment of the invention, the intermediary passive exteroceptive sensor is inclined with respect to a horizontal plan at an inclination angle between 10 and 20°.

According to an embodiment of the invention, the inclination angle of the intermediary passive exteroceptive sensor is between 10 and 15°, and advantageously is about 13°.

According to an embodiment of the invention, the upper passive exteroceptive sensor has a sensor orientation which is substantially horizontal. In other words, the upper passive exteroceptive sensor is arranged substantially horizontally.

According to an embodiment of the invention, the intermediary passive exteroceptive sensor includes two lenses and has a baseline, i.e. the distance between the two lenses, between 150 and 180 mm, for example of about 164 mm.

According to an embodiment of the invention, the upper passive exteroceptive sensor includes two lenses and has a baseline, i.e. the distance between the two lenses, of about 400 mm.

According to an embodiment of the invention, the two lenses of the intermediary passive exteroceptive sensor are symmetrically arranged on either side of the median longitudinal plane of the autonomous electric vehicle.

According to an embodiment of the invention, the two lenses of the upper passive exteroceptive sensor are symmetrically arranged on either side of the median longitudinal plane of the autonomous electric vehicle.

According to an embodiment of the invention, each lens of the intermediary passive exteroceptive sensor is narrow-angle lens.

According to an embodiment of the invention, each lens of the upper passive exteroceptive sensor is wide-angle lens.

According to an embodiment of the invention, each lens of the intermediary passive exteroceptive sensor is a DSL949 (marketed by Sunex).

According to an embodiment of the invention, each lens of the upper passive exteroceptive sensor is a DSL949.

According to an embodiment of the invention, each lens of the intermediary passive exteroceptive sensor is a DSL949 (marketed by Sunex).

According to an embodiment of the invention, each of the intermediary passive exteroceptive sensor and upper passive exteroceptive sensor includes a sensor element, such as a OV7962 (marketed by Omnivision).

According to an embodiment of the invention, at least one of the intermediary passive exteroceptive sensor and the upper passive exteroceptive sensor is a spectroscopic camera.

According to an embodiment of the invention, at least one of the intermediary passive exteroceptive sensor and the upper passive exteroceptive sensor is a spectroscopic video camera.

According to an embodiment of the invention, each of the intermediary passive exteroceptive sensor and the upper passive exteroceptive sensor is a spectroscopic camera, for example a spectroscopic video camera.

According to an embodiment of the invention, the autonomous electric vehicle further includes a GPS receiver, for example a RTK GPS receiver, i.e. a Real Time Kinematic GPS receiver, and/or a differential GPS receiver.

According to an embodiment of the invention, each of the lower active exteroceptive sensor and the intermediary active exteroceptive sensor has a measurement range up to 50 meters.

According to an embodiment of the invention, the upper scanning plane of the upper active exteroceptive sensor has a measurement range up to 100 meters.

According to an embodiment of the invention, the lower active exteroceptive sensor is configured to generate a lower scanning beam, for example an infrared scanning beam, the lower scanning plane being defined by the scanning displacement of the lower scanning beam. According to an embodiment of the invention, the wavelength of the lower scanning beam is between 850 and 950 nm, and for example about 905 nm.

According to an embodiment of the invention, the upper active exteroceptive sensor is configured to generate an upper scanning beam, for example an infrared scanning beam, the upper scanning plane being defined by the scanning displacement of the upper scanning beam. According to an embodiment of the invention, the wavelength of the upper scanning beam is between 850 and 950 nm, and for example about 905 nm.

According to an embodiment of the invention, the wavelength of each of the scanning beams generated by the upper active exteroceptive sensor is between 850 and 950 nm, and for example about 905 nm.

According to an embodiment of the invention, the upper active exteroceptive sensor is arranged on a roof of the autonomous electric vehicle.

According to an embodiment of the invention, the autonomous electric vehicle includes a manual control mode in which the autonomous electric vehicle is operated by an operator and an autonomous control mode in which the autonomous electric vehicle is automatically controlled based at least on the information obtained by the exteroceptive sensor set.

According to an embodiment of the invention, the autonomous electric vehicle includes a control unit configured to process and analyze, advantageously in real time, the information obtained by the exteroceptive sensor set, i.e. the information captured and/or detected by the lower active exteroceptive sensor, the intermediary active exteroceptive sensor, the intermediary passive exteroceptive sensor, the upper active exteroceptive sensor and the upper passive exteroceptive sensor, in order to identify objects and/or features in the environment in which the autonomous electric vehicle is located, including, for example, lane information, traffic signals and obstacles.

According to an embodiment of the invention, in the autonomous control mode, the control unit is configured to control the autonomous electric vehicle, such as the speed and the trajectory of the autonomous electric vehicle, based on the information obtained by the exteroceptive sensor set.

According to an embodiment of the invention, the exteroceptive sensor set further includes an additional lower active exteroceptive sensor arranged at a lower rear part of the autonomous electric vehicle and configured to sense or detect objects and/or features in the environment in which the autonomous electric vehicle is located, the additional lower active exteroceptive sensor providing a lower scanning plane substantially horizontal.

According to an embodiment of the invention, the additional lower active exteroceptive sensor is identical to the lower active exteroceptive sensor.

According to an embodiment of the invention, the additional lower active exteroceptive sensor has a same arrangement than the one of the lower active exteroceptive sensor.

According to an embodiment of the invention, the exteroceptive sensor set further includes an additional intermediary active exteroceptive sensor arranged at an intermediary rear part of the autonomous electric vehicle and configured to sense or detect objects and/or features in the environment in which the autonomous electric vehicle is located, the additional intermediary active exteroceptive sensor providing an intermediary scanning plane substantially horizontal.

According to an embodiment of the invention, the additional intermediary active exteroceptive sensor is identical to the intermediary active exteroceptive sensor.

According to an embodiment of the invention, the additional intermediary active exteroceptive sensor has a same arrangement than the one of the intermediary active exteroceptive sensor.

According to an embodiment of the invention, the exteroceptive sensor set further includes an additional upper active exteroceptive sensor arranged at an upper rear part of the autonomous electric vehicle and configured to sense or detect objects and/or features in the environment in which the autonomous electric vehicle is located, the additional upper active exteroceptive sensor providing an intermediary scanning plane substantially horizontal.

According to an embodiment of the invention, the additional upper active exteroceptive sensor is identical to the upper active exteroceptive sensor.

According to an embodiment of the invention, the additional upper active exteroceptive sensor has a same arrangement than the one of the upper active exteroceptive sensor.

According to an embodiment of the invention, the exteroceptive sensor set further includes at least one side exteroceptive sensor arranged at a side part of the autonomous electric vehicle and configured to sense or detect objects and/or features in the environment in which the autonomous electric vehicle is located.

According to an embodiment of the invention, the at least one side exteroceptive sensor has a field of view centered on an optical axis that is transverse with the longitudinal axis of the autonomous electric vehicle, and for example that is orthogonal to the longitudinal axis of the autonomous electric vehicle.

According to an embodiment of the invention, the at least one side exteroceptive sensor is a Lidar sensor, for example a single-layer Lidar sensor, such as a TIM Lidar.

According to an embodiment of the invention, the at least one side exteroceptive sensor has a measurement range up to 10 meters.

According to an embodiment of the invention, the at least one side exteroceptive sensor is arranged at a distance, from a support surface, particularly a horizontal support surface, on which the autonomous electric vehicle is located, between 0.50 and 1 meter, for example between 0.65 and 0.85 meter, and advantageously is about 0.74 meter.

According to an embodiment of the invention, the exteroceptive sensor set further includes a front side exteroceptive sensor arranged at a front side of the autonomous electric vehicle, and a rear side exteroceptive sensor arranged at a rear side of the autonomous electric vehicle. Advantageously, the front side exteroceptive sensor and the rear side exteroceptive sensor are arranged at opposite sides of the autonomous electric vehicle.

According to an embodiment of the invention, the autonomous electric vehicle further includes a proprioceptive sensor set configured to obtain information about a displacement of the autonomous electric vehicle.

According to an embodiment of the invention, the proprioceptive sensor set includes an inertial unit and wheel encoders.

According to an embodiment of the invention, the autonomous electric vehicle includes a memory configured to save the information obtained by the exteroceptive sensor set and/or the proprioceptive sensor set.

According to an embodiment of the invention, the autonomous electric vehicle is for example an automobile, a bus or a truck.

According to an embodiment of the invention, the lower active exteroceptive sensor, the intermediary active exteroceptive sensor and the upper active exteroceptive sensor are Lidar sensors, and the intermediary passive exteroceptive sensor and the upper passive exteroceptive sensor are stereoscopic cameras. Stereoscopic cameras can see any types of obstacles (having different sizes and colors) except that the distances estimated by such stereoscopic cameras are unreliable. Lidar sensors (for example VLP16 or Sick LMS151) are not dependent on the lighting conditions and are very precise for distance measurements. However Lidar sensors have low resolution and relatively low dot density. Stereoscopic cameras and Lidar sensors are thus complementary. Consequently, by combining stereoscopic cameras and Lidar sensors, the exteroceptive sensor set can reliably detect the information about the environment in which the autonomous electric vehicle is located.

According to an embodiment of the invention, at least one of, and for example each of, the lower active exteroceptive sensor and the intermediary active exteroceptive sensor is arranged in a median longitudinal plane of the autonomous electric vehicle.

These and other advantages of the present invention will become apparent upon reading the following description in view of the drawing attached hereto representing, as non-limiting examples, an embodiment of an autonomous electric vehicle according to the invention.

### BRIEF DESCRIPTION OF THE DRAWINGS

The following detailed description of one embodiment of the invention is better understood when read in conjunction with the appended drawings being understood, however, that the invention is not limited to the specific embodiment disclosed.

FIG. 1 is a perspective view of a fully autonomous electric vehicle according to the present invention.

FIG. 2 is a front view of the fully autonomous electric vehicle of FIG. 1.

FIG. 3 is a partial side view of the fully autonomous electric vehicle of FIG. 1.

FIG. 4 is a top view of the fully autonomous electric vehicle of FIG. 1 showing the fields of view a various lower active exteroceptive sensor.

FIG. 5 is a top view of the fully autonomous electric vehicle of FIG. 1 showing the fields of view a various intermediary active exteroceptive sensor.

### DETAILED DESCRIPTION OF THE INVENTION

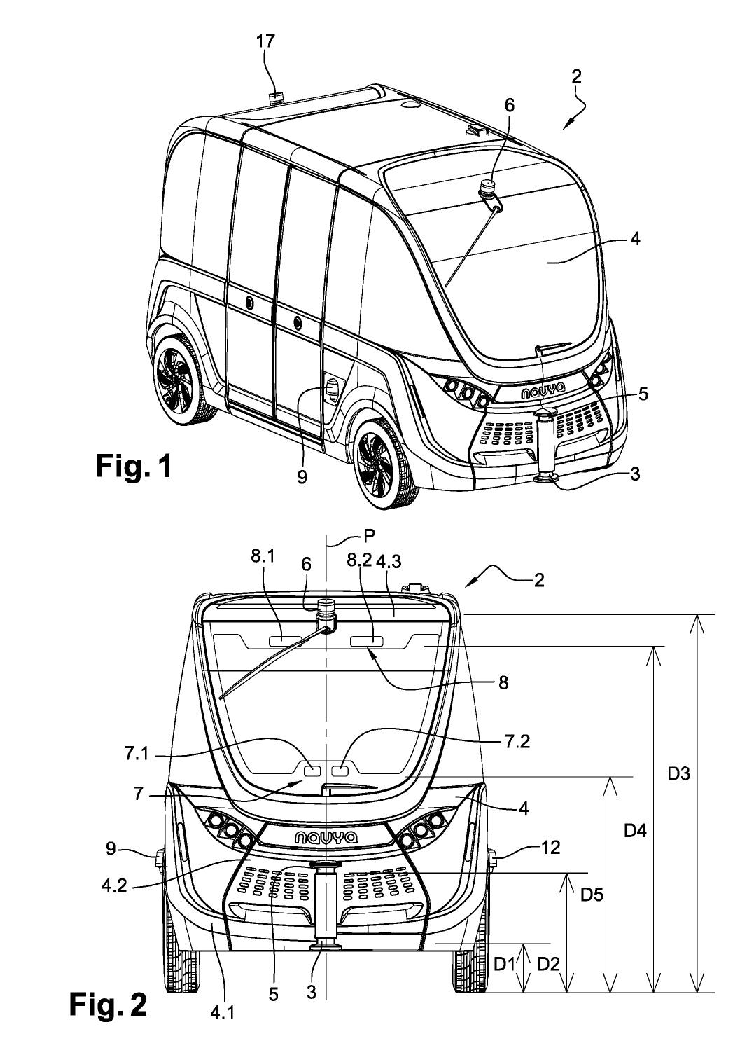

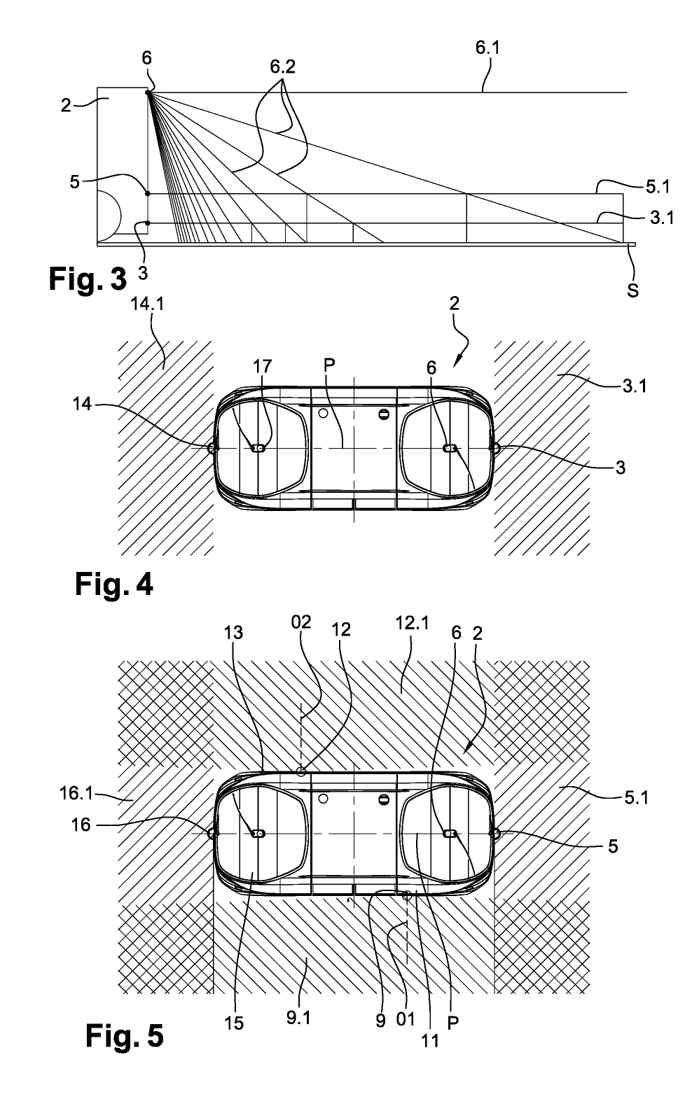

FIGS. 1 to 5 show a fully autonomous electric vehicle 2, also named fully automated (self-driving) vehicle, for transportation of goods and/or people. The fully autonomous electric vehicle 2 may be for example an automobile, a bus or a truck.

The fully autonomous electric vehicle 2 includes an exteroceptive sensor set configured to obtain information about an environment in which the fully autonomous electric vehicle 2 is located, and a proprioceptive sensor set configured to obtain information about a displacement of the fully autonomous electric vehicle 2. The proprioceptive sensor set may include, as known, for example an inertial unit and wheel encoders.

As better shown on FIG. 2, the exteroceptive sensor set includes a lower active exteroceptive sensor 3 arranged at a lower front part 4.1 of the front face 4 of the fully autonomous electric vehicle 2 and in a median longitudinal plane P of the fully autonomous electric vehicle 2, and configured to sense or detect objects and/or features in the environment in which the fully autonomous electric vehicle 2 is located. The lower active exteroceptive sensor 3 is advantageously a single-layer Lidar sensor, for example a Sick Lidar sensor, such as a Sick LMS151, and has a measurement range up to 50 meters.

The lower active exteroceptive sensor 3 includes a laser source (not shown on the figures) configured to emit a laser scanning beam, having for example a wavelength between 850 and 950 nm, such as about 905 nm, and a detector (not shown on the figures) configured to receive reflections of the respective laser scanning beam. Particularly the lower active exteroceptive sensor 3 provides a lower scanning plane 3.1 which is horizontal and is defined by the scanning displacement of the laser scanning beam emitted by the laser source of the lower active exteroceptive sensor 3.

Advantageously the lower active exteroceptive sensor 3 has a viewing angle of about 180°, and has a field of view 3.2 centered on the median longitudinal plane P of the fully autonomous electric vehicle 2.

The lower active exteroceptive sensor 3 is arranged at a first distance D1 from a horizontal support surface S on which the fully autonomous electric vehicle 2 is located. Advantageously the first distance D1 is between 0.20 and 0.40 meter, and for example is about 0.30 meter.

The exteroceptive sensor set further includes an intermediary active exteroceptive sensor 5 arranged at an intermediary front part 4.2 of the front face 4 of the fully autonomous electric vehicle 2 and in the median longitudinal plane P of the fully autonomous electric vehicle 2, and configured to sense or detect objects and/or features in the environment in which the fully autonomous electric vehicle is located. The intermediary active exteroceptive sensor 5 is a single-layer Lidar sensor, for example a Sick Lidar sensor, such as a Sick LMS151, and has a measurement range up to 50 meters.

The intermediary active exteroceptive sensor 5 includes a laser source (not shown on the figures) configured to emit a laser scanning beam, having for example a wavelength between 850 and 950 nm, and advantageously about 905 nm, and a detector (not shown on the figures) configured to receive reflections of the respective laser scanning beam. Particularly the intermediary active exteroceptive sensor 5 provides an intermediary scanning plane 5.1 which is horizontal and is defined by the scanning displacement of the laser scanning beam emitted by the laser source of the intermediary active exteroceptive sensor 5.

Advantageously the intermediary active exteroceptive sensor 5 has a viewing angle of about 180° and has a field of view 5.2 centered on the median longitudinal plane P of the fully autonomous electric vehicle 2.

The intermediary active exteroceptive sensor 5 is arranged at a second distance D2 from the horizontal support surface S on which the fully autonomous electric vehicle 2 is located. Advantageously the second distance D2 is between 0.65 and 0.85 meter, and for example is about 0.74 meter.

The exteroceptive sensor set also includes an upper active exteroceptive sensor 6 arranged at an upper front part 4.3 of the front face 4 of the fully autonomous electric vehicle 2 and in the median longitudinal plane P of the fully autonomous electric vehicle 2, and configured to sense or detect objects and/or features in the environment in which the fully autonomous electric vehicle 2 is located. The upper active exteroceptive sensor 6 is a multi-layer Lidar sensor, advantageously a 16-layer Lidar sensor, such as a VLP-16, and has a measurement range up to 100 meters.

Advantageously the upper active exteroceptive sensor 6 is inclined downwardly with respect to the horizontal plane at an inclination angle between 10 and 20 degrees, and for example about 15 degrees, and the upper active exteroceptive sensor 6 has a 30° vertical field of view with ±15° up and down.

The upper active exteroceptive sensor 6 includes a laser source (not shown on the figures) configured to emit, for example simultaneously, laser scanning beams, each having for example a wavelength between 850 and 950 nm, and advantageously about 905 nm, in different directions, and a detector (not shown on the figures) configured to receive reflections of the respective laser scanning beams.

Particularly the upper active exteroceptive sensor 6 provides an upper scanning plane 6.1 which is substantially horizontal and a plurality of successive inclined scanning planes 6.2 having increasing angular orientations, measured along a common axis, with respect to the upper scanning plane 6.1. Each of the upper scanning plane 6.1 and the inclined scanning planes 6.2 is defined by the scanning displacement of a respective one of the laser scanning beams emitted by the upper active exteroceptive sensor 6. According to the embodiment shown on the figures, the upper active exteroceptive sensor 6 is configured to provide fifteen inclined scanning planes 6.2 from about −2° with a horizontal plane to about −30° with the horizontal plane, and each of the upper scanning plane 6.1 and of the inclined scanning planes 6.2 has a vertical angular resolution of about 2°. Please note that, on FIG. 3, the distances between the fully autonomous electric vehicle 2 and the impact zones of the inclined scanning planes 6.2 with the support surface S have been shortened in order to be visible, which leads however to an inclination of the various inclined scanning planes 6.2 that is not consistent with the real orientation of said inclined scanning planes 6.2.

Advantageously the upper active exteroceptive sensor 6 is arranged at a third distance D3 from the horizontal support surface S. The third distance D3 is higher than 2.20 meters, advantageously between 2.20 and 2.50 meters, and for example is about 2.34 meters.

Furthermore the exteroceptive sensor set includes an intermediary passive exteroceptive sensor 7 arranged at the intermediary front part 4.2 of the front face 4 of the fully autonomous electric vehicle 2 and an upper passive exteroceptive sensor 8 arranged at the upper front part 4.3 of the front face 4 of the fully autonomous electric vehicle 2. The intermediary passive exteroceptive sensor 7 and the upper passive exteroceptive sensor 8 are each configured to capture images or a video of the environment in which the fully autonomous electric vehicle 2 is located. Each of the intermediary passive exteroceptive sensor 7 and the upper passive exteroceptive sensor 8 is a spectroscopic camera, and advantageously a spectroscopic video camera.

The intermediary passive exteroceptive sensor 7 and the upper passive exteroceptive sensor 8 are respectively arranged at a fourth distance D4 and a fifth distance D5 from the horizontal support surface S. Advantageously the fourth distance D4 is between 1.10 and 1.40 meter, and for example about 1.38, and the fifth distance D5 is between 2 and 2.50 meters, and for example is about 2.34 meters.

According to an embodiment of the invention, the intermediary passive exteroceptive sensor 7 is inclined with respect to a horizontal plan at an inclination angle between 10 and 15°, and advantageously about 13°, and the upper passive exteroceptive sensor 8 has a sensor orientation which is horizontal.

The intermediary passive exteroceptive sensor 7 may include two narrow-angle lenses 7.1, 7.2 and may have a baseline, i.e. the distance between the two narrow-angle lenses 7.1, 7.2, between 150 and 180 mm, for example of about 164 mm, while the upper passive exteroceptive sensor 8 may include two wide-angle lenses 8.1, 8.2 and may have a baseline of about 400 mm. Advantageously, the two lenses 7.1, 7.2 of the intermediary passive exteroceptive sensor 7 are symmetrically arranged on either side of the median longitudinal plane P of the fully autonomous electric vehicle 2, and the two lenses 8.1, 8.2 of the upper passive exteroceptive sensor 8 are also symmetrically arranged on either side of the median longitudinal plane P.

According to an embodiment of the invention, each lens of the intermediary passive exteroceptive sensor 7 and the upper passive exteroceptive sensor 8 is a DSL949 (marketed by Sunex), and each of the intermediary passive exteroceptive sensor 7 and the upper passive exteroceptive sensor 8 includes a sensor element, such as a OV7962 (marketed by Omnivision).

According to an embodiment of the invention, the optical axes of the lens of the upper passive exteroceptive sensor 8 are substantially parallel with the longitudinal axis of the fully autonomous electric vehicle 2, and the optical axes of the lens of the intermediary passive exteroceptive sensor 7 are substantially parallel with the median longitudinal plane P of the fully autonomous electric vehicle.

Moreover the exteroceptive sensor set includes a front side exteroceptive sensor 9 arranged at a right front side 11 of the fully autonomous electric vehicle 2, and a rear side exteroceptive sensor 12 arranged at a left rear side 13 of the fully autonomous electric vehicle 2. The front side exteroceptive sensor 9 and the rear side exteroceptive sensor 12 are configured to sense or detect objects and/or features in the environment in which the fully autonomous electric vehicle 2 is located. Advantageously each of the front side exteroceptive sensor 9 and the rear side exteroceptive sensor 12 is a Lidar sensor, for example a single-layer Lidar sensor, such as a TIM Lidar, and has a measurement range up to 10 meters.

According to an embodiment of the invention, the front side exteroceptive sensor 9 has a field of view 9.1 centered on an optical axis O1 that is transverse with the median longitudinal plane P of the fully autonomous electric vehicle 2, and for example orthogonal to the median longitudinal plane P, and the rear side exteroceptive sensor 12 has a field of view 12.1 centered on an optical axis O2 that is transverse with the median longitudinal plane P of the fully autonomous electric vehicle 2, and for example orthogonal to the median longitudinal plane P.

According to an embodiment of the invention, the front side exteroceptive sensor 9 and the rear side exteroceptive sensor 12 are respectively arranged at a distance, from the horizontal support surface S, between 0.65 and 0.85 meter, and advantageously about 0.74 meter.

The exteroceptive sensor set may further include:

an additional lower active exteroceptive sensor 14 arranged at a lower rear part of a rear face 15 of the fully autonomous electric vehicle 2 and providing a lower scanning plane 14.1 substantially horizontal, advantageously the additional lower active exteroceptive sensor 14 may be identical to the lower active exteroceptive sensor 3 and may have the same arrangement than the one of the lower active exteroceptive sensor 3,

an additional intermediary active exteroceptive sensor 16 arranged at an intermediary rear part of the rear face 15 of the fully autonomous electric vehicle 2 and providing an intermediary scanning plane 16.1 substantially horizontal, advantageously the additional intermediary active exteroceptive sensor 16 may be identical to the intermediary active exteroceptive sensor 5 and may have the same arrangement than the one of the intermediary active exteroceptive sensor 5,

an additional upper active exteroceptive sensor 17 arranged at an upper rear part of the rear face 15 of the fully autonomous electric vehicle, advantageously the additional upper active exteroceptive sensor 17 may be identical to the upper active exteroceptive sensor 6 and may have the same arrangement than the one of the upper active exteroceptive sensor 6.

The fully autonomous electric vehicle 2 further includes a memory configured to save the information obtained by the exteroceptive sensor set and/or the proprioceptive sensor set, and a GPS receiver, for example a RTK GPS receiver, i.e. a Real Time Kinematic GPS receiver, and/or a differential GPS receiver.

The fully autonomous electric vehicle also includes a control unit 19 configured control the fully autonomous electric vehicle 2 in a manual control mode in which the fully autonomous electric vehicle 2 is operated by an operator and in an autonomous control mode in which the fully autonomous electric vehicle 2 is automatically controlled based on the information obtained by the exteroceptive sensor set and the proprioceptive sensor set.

Particularly, the control unit 19 is configured to process and analyze the information obtained by the exteroceptive sensor set and the proprioceptive sensor set, in order to identify objects and/or features in the environment in which the fully autonomous electric vehicle is located, including for example lane information, traffic signals and obstacles, and configured to control, in the autonomous control mode, the fully autonomous electric vehicle 2 based on the information obtained by the exteroceptive sensor set and the proprioceptive sensor set.

Of course, the invention is not restricted to the embodiment described above by way of non-limiting example, but on the contrary it encompasses all embodiments thereof.

1. Autonomous electric vehicle for transportation of goods and/or people, including an exteroceptive sensor set configured to obtain information about an environment in which the autonomous electric vehicle is located, the exteroceptive sensor set including:
a lower active exteroceptive sensor arranged at a lower front part of the autonomous electric vehicle and configured to sense or detect objects and/or features in the environment in which the autonomous electric vehicle is located, the lower active exteroceptive sensor providing a lower scanning plane substantially horizontal,
an intermediary active exteroceptive sensor arranged at an intermediary front part of the autonomous electric vehicle and configured to sense or detect objects and/or features in the environment in which the autonomous electric vehicle is located, the intermediary active exteroceptive sensor providing an intermediary scanning plane substantially horizontal,
an intermediary passive exteroceptive sensor arranged at the intermediary front part of the autonomous electric vehicle and configured to capture images or a video of the environment in which the autonomous electric vehicle is located,
an upper active exteroceptive sensor arranged at an upper front part of the autonomous electric vehicle and configured to sense or detect objects and/or features in the environment in which the autonomous electric vehicle is located, the upper active exteroceptive sensor providing a plurality of scanning planes, and
an upper passive exteroceptive sensor arranged at the upper front part of the autonomous electric vehicle and configured to capture images or a video of the environment in which the autonomous electric vehicle is located.

2. The autonomous electric vehicle according to claim 1, wherein the lower active exteroceptive sensor, the intermediary active exteroceptive sensor and the upper active exteroceptive sensor are arranged at different heights.

3. The autonomous electric vehicle according to claim 1, wherein at least one of the lower active exteroceptive sensor, the intermediary active exteroceptive sensor and the upper active exteroceptive sensor is a Lidar sensor.

4. The autonomous electric vehicle according to claim 1, wherein the upper active exteroceptive sensor is a multi-layer Lidar sensor.

5. The autonomous electric vehicle according to claim 1, wherein the upper active exteroceptive sensor is configured to provide an upper scanning plane substantially horizontal and a plurality of inclined scanning planes which are inclined with respect to a horizontal plane.

6. The autonomous electric vehicle according to claim 1, wherein the upper active exteroceptive sensor is configured to provide an upper scanning plane substantially horizontal and a plurality of successive inclined scanning planes having increasing angular orientations, measured along a common axis, with respect to the upper scanning plane.

7. The autonomous electric vehicle according to claim 1, wherein the upper active exteroceptive sensor is inclined with respect to a horizontal plane.

8. The autonomous electric vehicle according to claim 7, wherein the upper active exteroceptive sensor is inclined downwardly at an inclination angle between 10 and 20 degrees.

9. The autonomous electric vehicle according to claim 1, wherein the upper active exteroceptive sensor has a 30° vertical field of view.

10. The autonomous electric vehicle according to claim 1, wherein at least one of the lower active exteroceptive sensor and the intermediary active exteroceptive sensor is a single-layer Lidar sensor.

11. The autonomous electric vehicle according to claim 1, wherein at least one of the lower active exteroceptive sensor and the intermediary active exteroceptive sensor has a viewing angle of at least 160°.

12. The autonomous electric vehicle according to claim 1, wherein the lower active exteroceptive sensor is arranged at a first distance, from a support surface on which the autonomous electric vehicle is located, between 0.20 and 0.40 meter.

13. The autonomous electric vehicle according to claim 1, wherein the intermediary active exteroceptive sensor is arranged at a second distance, from a support surface on which the autonomous electric vehicle is located, between 0.50 and 1 meter.

14. The autonomous electric vehicle according to claim 1, wherein the upper active exteroceptive sensor is arranged at a third distance, from a support surface on which the autonomous electric vehicle is located, higher than 2.20 meters.

15. The autonomous electric vehicle according to claim 1, wherein the intermediary passive exteroceptive sensor is arranged at a fourth distance, from a support surface on which the autonomous electric vehicle is located, between 1 and 1.40 meter.

16. The autonomous electric vehicle according to claim 1, wherein the upper passive exteroceptive sensor is arranged at a fifth distance, from a support surface on which the autonomous electric vehicle is located, higher than 2 meters.

17. The autonomous electric vehicle according to claim 1, wherein the intermediary passive exteroceptive sensor is inclined with respect to a horizontal plan at an inclination angle between 10 and 20°.

18. The autonomous electric vehicle according to claim 1, wherein the upper passive exteroceptive sensor has a sensor orientation which is substantially horizontal.

19. The autonomous electric vehicle according to claim 1, wherein at least one of the intermediary passive exteroceptive sensor and the upper passive exteroceptive sensor is a spectroscopic camera.

20. The autonomous electric vehicle according to claim 1, further including a GPS receiver.

21. The autonomous electric vehicle according to claim 1, further including a proprioceptive sensor set configured to obtain information about a displacement of the autonomous electric vehicle.
